(19) United States
(12) Patent Application Publication
(10) Pub. No.: US 2014/0143007 A1
(43) Pub. Date: May 22, 2014

(54) FRONTLOADING PRODUCT INVENTORY

(71) Applicant: TARGET BRANDS, INC., Minneapolis, MN (US)

(72) Inventors: Stacey L. Faulkenberg, Minneapolis, MN (US); Lisa Anne Miller, Roseville, MN (US); Christoph Jonathan Steffen Meyer, Minneapolis, MN (US)

(73) Assignee: TARGET BRANDS, INC., Minneapolis, MN (US)

(21) Appl. No.: 13/682,286

(22) Filed: Nov. 20, 2012

(51) Int. Cl. G06Q 10/06

(52) U.S. Cl. CPC G06Q 10/06315
USPC 705/7.25

(57) ABSTRACT

An example computing device may generate a plurality of snowfall categories for a region and a plurality of snowfall category combinations at the region for a time frame that includes a plurality of time segments. The device may calculate a forecast of unit sales of a weather-dependent product over the time frame for each snowfall category combination based on past weather data for the region and past sales data of the weather-dependent product. The device may calculate a probability that each snowfall category combination will occur in the time frame. The device may determine a quantity of the weather-dependent product to place in inventory prior to or at the beginning of the time frame configured to approximate demand for the product over the entire time frame based on forecasted unit sales and the probabilities that each snowfall category combination will occur in the time frame.

### TECHNICAL FIELD

In general, the present disclosure relates to computing systems for business planning.

### BACKGROUND

Business entities, such as retail chains, vendors, franchisors, and others, may supply inventory of products to one or more store locations. The nature of the supplied products may vary. For example, certain products may be suited to particular weather conditions. Additionally, consumer demand for these products may vary based on weather conditions in combination with other factors, such as characteristics associated with particular store locations.

### SUMMARY

In general, the present disclosure is directed to techniques for forecasting sales in designated regions and/or particular store locations based on information such as weather forecasts, past sales data, profit/loss statistics from past years, etc. Based on the forecasted sales and other related factors, computing systems may determine a quantity of a product to deploy to a region, the amount of which product is selected to approximate demand for the product over a given time frame, e.g., over a season like winter. Throughout this disclosure, this quantity determined for a region may be referred to as a “frontload inventory quantity,” and the process of stocking the frontload inventory quantity for a region may be referred to as “frontloading.” Optionally, in scenarios where a particular region includes multiple store locations, the computing systems may implement the techniques to allocate portions of the frontload inventory quantity among the store locations in the region. The techniques may enable the computing systems to allocate the frontload inventory quantity among multiple store locations based on various criteria, including historical data pertaining to each store location in the region.

In one example, a method includes generating, by a computing device, a plurality of weather classifications for a location based on past weather data for the location, wherein each weather classification represents a level of a characteristic of the weather at the location, generating, by the computing device, a plurality of weather scenarios for a time frame comprising a plurality of time segments over which sales of a product will occur in the future, wherein each weather scenario comprises a different combination of weather classifications assigned to each of the time segments in the time frame, calculating a forecast of unit sales of the product over the time frame for each weather scenario based on the past weather data for the location and past sales data associated with both the product and the weather classifications, calculating a probability that each weather scenario will occur in the time frame, iteratively selecting a plurality of test frontload inventory quantities for the product and calculating a function comprising the sum of the products of the probability that each weather scenario will occur and the difference between each test frontload inventory quantity and the forecasted unit sales of the product for each weather scenario, wherein a frontload inventory quantity comprises a quantity of the product to place in inventory prior to or at the beginning of the time frame configured to approximate demand for the product over the entire time frame, and selecting one of the test frontload inventory quantities as a final frontload inventory quantity for the product based on the calculated function for each of the test frontload inventory quantities.

In another example, a computing device includes a computer readable storage memory and at least one processor. The at least one processor is configured to access information stored on the computer readable storage medium and to perform operations including generating a plurality of snowfall categories for a region based on past weather data for the region, wherein each snowfall category represents a range of a characteristic of the weather at the region, generating a plurality of snowfall category combinations for a time frame comprising a plurality of time segments over which sales of a weather-dependent product will occur in the future, wherein each snowfall category combination comprises a different combination of snowfall categories assigned to each of the time segments in the time frame, calculating a forecast of unit sales of the weather-dependent product over the time frame for each snowfall category combination based on the past weather data for the region and past sales data associated with both the weather-dependent product and the snowfall categories, calculating a probability that each snowfall category combination will occur in the time frame, iteratively selecting a plurality of preliminary frontload inventory quantities for the weather-dependent product and calculate a function comprising the sum of the weather-dependent products of the probability that each snowfall category combination will occur and the difference between each preliminary frontload inventory quantity and the forecasted unit sales of the weather-dependent product for each snowfall category combination, wherein a frontload inventory quantity comprises a quantity of the weather-dependent product to place in inventory prior to or at the beginning of the time frame configured to approximate demand for the product over the entire time frame, and selecting one of the preliminary frontload inventory quantities as a frontload inventory quantity for the weather-dependent product based on the calculated function for each of the preliminary frontload inventory quantities.

In another example, a computer-readable storage medium encoded with instructions that, when executed, cause one or more processors of a computing device to generate a plurality of weather classifications for a location based on past weather data for the location, wherein each weather classification represents a level of a characteristic of the weather at the location, generate a plurality of weather scenarios for a time frame comprising a plurality of time segments over which sales of a product will occur in the future, wherein each weather scenario comprises a different combination of weather classifications assigned to each of the time segments in the time frame, calculate a forecast of unit sales of the product over the time frame for each weather scenario based on the past weather data for the location and past sales data associated with both the product and the weather classifications, calculate a probability that each weather scenario will occur in the time frame, determine a frontload inventory quantity for the product based on the calculated forecast of unit sales of the product over the time frame and the probabilities that each weather scenario will occur in the time frame.

The techniques described herein may provide certain potential advantages. For example, a business entity may implement the techniques of this disclosure to frontload certain weather-dependent goods in a region over a predetermined time frame, based on probabilities of particular weather scenarios occurring in the future (e.g., extrapolated from historical weather data). By frontloading inventory of the product in the region over the time frame, and optionally allocating the frontload inventory quantity over multiple store locations, the business entity may deploy inventory of the product in a cost-effective and profitable manner. For example, the business entity may predict a demand spike in a region for a particular product based on weather forecasts for the region during the time frame. Based on the predicted demand spike, the business entity may frontload inventory of the product so as to adequately meet demand over the time frame, while not exceeding demand in such a way that causes an excess surplus of the product after the end of the time frame. By implementing the frontloading techniques described herein, the business entity may mitigate monetary losses caused by failure to meet consumer demand over the time frame, as well as monetary losses caused by having to sell surplus inventory of the good at prices below the cost paid by the business entity. In this manner, techniques of this disclosure may enable a business entity to more efficiently and profitably deploy available inventory of products by predicting demand and sales figures based on weather conditions and other related factors.

The details of one or more examples are set forth in the accompanying drawings and the description below. Other features, objects, and advantages of examples according to this disclosure will be apparent from the description and drawings, and from the claims.

### BRIEF DESCRIPTION OF DRAWINGS

FIG. 1 is a conceptual diagram illustrating an example system by which one or more computing devices may frontload inventory of a product, and allocate the frontloaded inventory among multiple store locations, in accordance with one or more aspects of this disclosure.

FIG. 2 is a block diagram illustrating details of an example computing device that may perform one or more inventory frontloading and allocation techniques of this disclosure.

FIG. 3 is a flowchart illustrating an example process that a computing device may perform to implement one or more product inventory frontloading and allocation techniques of this disclosure.

FIG. 4 is a graph illustrating sales clustering of a precipitation-specific product in a particular region, across varying levels of precipitation.

FIG. 5 is a graph illustrating allocation of frontload inventory across various store locations with a particular region.

### DETAILED DESCRIPTION

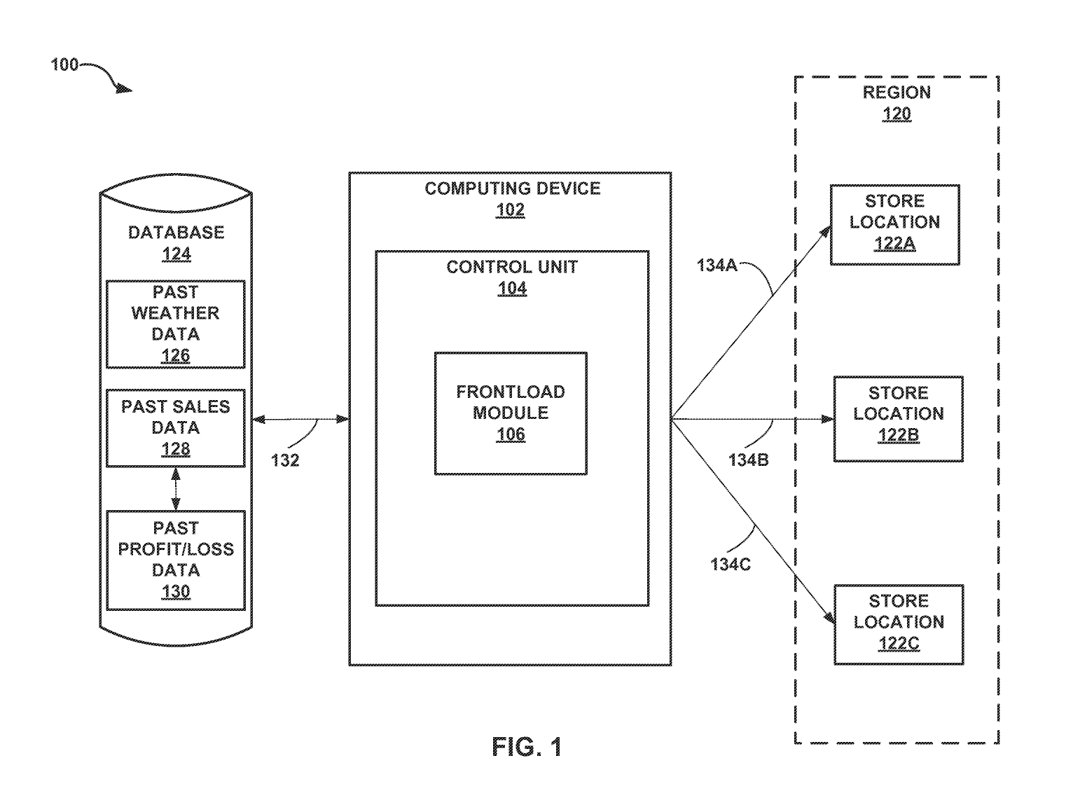

FIG. 1 is a conceptual diagram illustrating an example system by which one or more computing devices may frontload inventory of a product, and allocate the frontloaded inventory among multiple store locations, in accordance with one or more aspects of this disclosure. System 100 of FIG. 1 includes computing device 102 and database 124. Additionally, system 100 includes store locations 122A-122C (hereinafter, “store locations 122”) that are located within region 120.

As shown in FIG. 1, computing device 102 includes control unit 104. Control unit 104 may, in various examples, comprise any combination of one or more processors, one or more field programmable gate arrays (FPGAs), one or more application specific integrated circuits (ASICs), and one or more application specific standard products (ASSPs). Control unit 104 may also comprise memory, both static (e.g., hard drives or magnetic drives, optical drives, FLASH memory, EPROM, EEPROM, etc.) and dynamic (e.g., RAM, DRAM, SRAM, etc.), or any other non-transitory computer readable storage medium capable of storing instructions that cause the one or more processors to perform the efficient network management techniques described in this disclosure. Thus, control unit 104 may represent hardware or a combination of hardware and software to support the below described components, modules or elements, and the techniques should not be strictly limited to any particular example described below.

Control unit 104 further includes frontload module 106. Frontload module 106 may be configured or otherwise operable to perform one or more of the techniques described herein. In examples, frontload module 106 may provide functionalities that enable computing device 102 to implement the product inventory frontloading techniques described herein. Additionally, in the context of computing device 102, frontload module 106 may enable computing device 102 to allocate a frontload inventory quantity for region 120 among store locations 122, based on various criteria.

System 100 also includes database 124. While illustrated in FIG. 1 as being separate from computing device 102, database 124 may, in various examples, be included in computing device 102 (e.g., by way of an internal storage device, etc.). In the example of system 100, computing device 102 may access database 124 in any of a number of ways, including through the use of a communicative connection. Examples of communicative connections may include wired or wireless direct connections, wired or wireless network connections (e.g., over the Internet), and/or any combinations thereof.

Database 124 may store various types and amounts of data. FIG. 1 illustrates some examples of such data, including past weather data 126, past sales data 128, and past profit/loss data 130. Past weather data 126 may include weather data collected over a predetermined period of time (e.g., 20 years), and may be categorized/organized according to region. A region may correspond to various levels of geographic area, such as a state, county, city, metropolitan area, and others. A region may be determined based on geography, homogeneity of weather conditions within the region, a number of store locations within the region, similar sales data of one or more products within the region, etc.

As shown, database 124 may also store past sales data 128. Past sales data 128 may correspond to quantities of products sold and sales revenues and/or profits generated therefrom at various regions and/or store locations. Additionally, past sales data 128 may correspond to, and be categorized by, various products. For example, past sales data 128 may include sales data corresponding to several products sold in several regions, including region 120 illustrated in FIG. 1. For purposes of illustration, past sales data 128 will be described herein with reference to region 120 and a single product.

Database 124 may also store past profit/loss data 130. As shown, past profit/loss data 130 may arise from, and/or give rise to, past sales data 128. For example, past profit/loss data 130 may be derived using a function of past sales data 128 and prices paid for the corresponding inventory quantity of the product. Conversely, past sales data 128 may be derived as a function of past profit/loss data 130 and the prices paid for the corresponding inventory quantity of the product.

To implement the inventory frontloading techniques of this disclosure, computing device 102 and/or components thereof may draw data 132 from database 124. Data 132 may include portions of one or more of past weather data 126, past sales data 128, and past profit/loss data 130. In some instances, data 132 may be generated using one or more of past weather data 126, past sales data 128, and past profit/loss data 130. Using data 132, frontload module 106 may determine a frontload inventory quantity to deploy to region 120. Additionally, in some instances, frontload module 106 may use data 132 to allocate portions of the frontload inventory quantity among store locations 122. More specifically, in this example, frontload module 106 may divide the frontload inventory quantity assigned to region 120 (into equal or unequal portions), and allocate the divided portions among store locations 122. In the specific example of FIG. 1, these divided portions are represented by store allocations 134A-134C (collectively, “store allocations 134”).

Frontload module 106 may determine the frontload inventory quantity and store allocations 134 by performing a variety of analyses on data 132. For example, computing device 102 may request data 132 such that data 132 includes past weather data 126 and past profit/loss data 130 as both pertain to a location, such as region 120. Additionally, frontload module 106 may request data 132 as it pertains to a time frame over which sales of a product will occur in the future. In turn, the time frame may include one or more time segments. For example, frontload module 106 may select a time frame having a length of nine weeks. In this example, each week may serve as a time segment, i.e. the time frame may include a total of nine time segments.

Using past weather data 126, frontload module 106 may generate a plurality of weather scenarios for a given time frame, which may include a number of time segments. For example, frontload module 106 may generate a number of weather scenarios for a season like winter that includes a number of weeks, e.g., nine weeks. In one example, frontload module 106 may generate a set of weather classifications, each of which weather classification may represent a level of a characteristic of the weather at region 120. In various examples, the weather characteristic may include precipitation, and each weather classification may represent a precipitation level. For example, frontload module 106 may select weather classifications from a group that includes a high-precipitation category, a low-precipitation category, and a zero-precipitation category. In turn, each precipitation category may correspond to a rainfall category (e.g., expressed as a range of inches of rainfall), a snowfall category (e.g., expressed as a range of inches of snowfall), etc. In various instances, the weather classifications may include multiple levels of a characteristic of weather. In one of the above examples, the high-precipitation weather classification may include multiple levels, e.g., multiple increments of inches of snowfall that have been clustered together and categorized together as “high.” The levels of precipitation or other characteristic of weather may be referred to herein as “segmented levels” of snowfall characteristic of weather.

In another example, each weather classification may correspond to a temperature range, such as a low-temperature category, an intermediate-temperature category, a high-temperature category, etc. In these examples, each weather classification may be expressed in terms of degrees, in various scales, such as Fahrenheit, Celsius/Centigrade, Kelvin, etc. In this manner, frontload module 106 may utilize weather classifications based on levels of a variety of weather-based characteristics in determining frontload inventory amounts for region 120. Regardless of the particular type or number of weather classifications, frontload module 106 may generate the weather scenarios by generating all of the possible combinations of weather classifications associated with each time segment in the time frame.

Additionally, frontload module 106 may calculate a probability that each weather scenario will occur in the time frame under consideration. To illustrate, in an example where frontload module 106 generates a set of three weather classifications, and where the time frame includes nine segments (e.g., weeks), frontload module 106 may generate a total of 19,683 (i.e., 3⁹) possible weather scenarios. In other words, each weather scenario may include a different combination of weather classifications assigned to each time segment of the time frame. In turn, frontload module 106 may determine a probability (e.g., ranging from 0 to 1) associated with each weather classification during each segment of the time frame.

In various examples, frontload module 106 may determine the probabilities based on past weather data included in data 132. For instance, frontload module 106 may use past weather data corresponding to a number of years (e.g., for the past twenty years) in determining a frequency of each weather classification in a corresponding time segment. Based on the determined frequency of each weather classification with respect to each time segment in the past, frontload module 106 may generate the probability that each weather classification will occur in a specific time segment of the time frame.

For each possible weather scenario that may occur over the time frame, frontload module 106 may also calculate a forecast of unit sales of one or more products over the time frame. In examples, frontload module 106 may calculate the forecast of unit sales of the product(s) based on past weather data and past sales data of the product(s) included in data 132. The forecasted unit sales may be calculated by frontload module 106 for each weather classification and then a forecast for the time frame for each weather scenario may be determined based on the respective forecasted unit sales for each weather classification. As one illustrative example, frontload module 106 may base the calculation on past sales data of a particular product during a corresponding past time segment associated with each available weather classification. By summing the past sales across all time segments for the time frame (in each weather scenario), frontload module 106 may calculate a separate forecast of unit sales of the product over the time frame for each weather scenario.

Additionally, frontload module 106 may iteratively select a set, or plurality, of test frontload inventory quantities (also referred to herein as “preliminary frontload inventory quantities”) for the product(s) and calculate a function that includes the sum of the products of the probability that each weather scenario will occur and the difference between each test frontload inventory quantity and the forecasted unit sales of the product(s) for each weather scenario. In various examples, a test frontload inventory quantity may include or otherwise indicate a quantity of the product(s) to place in inventory prior to or at the beginning of the time frame. More specifically, each test frontload inventory quantity may correspond to a possible quantity of the product to place in inventory across region 120.

Frontload module 106 may select one of the test frontload inventory quantities as a final frontload inventory quantity for the product based on the calculated function for each test frontload inventory quantity. An example of the function calculated by frontload module 106 appears as follows:

Σ_{xεX}P(X=x)(wₑ·eₓ+wₛ·sₓ)

subject to:

U−fₓ≦eₓ, for xεX.

fₓ−U≦sₓ, for xεX,

eₓ,sₓ≧0, for xεX.

The function described above may form a portion of an optimization model that frontload module 106 may use to arrive at a final frontload quantity. More specifically, frontload module 106 may iteratively calculate the above function for different test frontload inventory quantities (or values of ‘U’) and by minimizing the function across all test frontload quantities may determine a final frontload inventory quantity. The terms of the foregoing function are dependent or based on the test frontload quantities, the forecasted unit sales for the various weather scenarios for the time frame, and the probabilities of each of the weather scenarios described above. Thus, once an initial, “test” frontload quantity is selected, frontload module 106 may solve the above equation for all possible weather scenarios for the selected test frontload quantity.

In the foregoing function employed by frontload module 106, U is the frontload inventory quantity. X is the set of all possible weather scenarios, P(X=x) is the probability of weather scenario x, and fₓ is the forecasted unit sales for weather scenario x. The probability of each weather scenario x in the set of all scenarios X may be calculated by frontload module 106 as the product of each probability associated with each weather classification assigned to each time segment in the time frame for the weather scenario. The individual probabilities associated with each weather classification assigned to each time segment in the time frame for the weather scenario may be determined by frontload module 106 based on past weather data 126 as described above.

In the foregoing function employed by frontload module 106, eₓ, sₓ are the estimated excess and shortage inventory quantities, respectively, for weather scenario x. the excess and shortage inventory quantities represent the difference between each test frontload inventory quantity, U, and the forecasted unit sales of the product for each weather scenario x, fₓ. For example, frontload module 106 may generate a value of eₓ (which represents an estimated excess amount of the product in weather scenario x) by subtracting the forecasted unit sales for scenario x, fₓ, from the value of U, in situations where U is greater than fₓ. Conversely, in situations where U is less than fₓ, frontload module 106 may calculate a shortage amount (sₓ) of the product by subtracting U from fₓ. It should be noted that a given weather scenario x may be associated with only one of an estimated excess or shortage amount. This is expressed above as the constraint that eₓ, sₓ≧0, for xεX. In practice, therefore, to account for this constraint, frontload module 106 may assign a value of zero to sₓ where eₓ has a negative value, and vice versa.

As shown above, in calculating the function for a weather scenario x, frontload module 106 may multiply each of eₓ and sₓ by wₑ and wₛ, respectively. The terms wₑ and wₛ may represent weights that frontload module 106 attaches to estimated excess amounts and shortage amounts of a product, respectively. Frontload module 106 may attach weights to the estimated excess and shortage amounts in order to skew the calculation in favor of one of having one or more store locations 122 be out-of-stock of the product sometime prior to the end of the time frame or having an excess (or surplus) of the product after expiration of the time frame. The determination of the bias toward surplus product after the time frame or running out of stock sometime close to the end of the time frame may be assigned based on various criteria, including past sales data.

In one illustrative example, frontload module 106 may skew the calculation such that store locations 122 have a 95% chance of maintaining stock (e.g., by having an excess) of the product at the end of the time frame as opposed to being out-of-stock of the product at or before the end of the time frame. In this example, frontload module 106 may assign a value of nineteen to wₑ and a value of one to wₛ. In this example, in order to be in stock 95% of the time, frontload module 106 may assign weights wₑ and wₛ such that wₑ represents 95% of the total of the two weights. Thus, frontload module 106 may generate the equation wₑ(wₑ+wₛ)=0.95, which may also be rewritten as wₑ=19wₛ. Frontload module 106 may select any combination of weights satisfying the preceding equality to arrive at the 95% in stock result. In this manner, frontload module 106 may implement the techniques of this disclosure to favor one of an excess and a shortage amount of a product over the other. In turn, by catering to consumer demand using a pre-stocked inventory, the retail chain may avoid lost sales (e.g. from consumers who may not find the product at store locations 122 and move to a rival retailer), lost profits resulting from the lost sales, diminished customer goodwill, and others.

In the function presented above, once frontload module 106 calculates each of the terms of the function, P(X=x), eₓ, and sₓ, frontload module 106 may sum the results of the function for all of the weather scenarios in the set of possible weather scenarios X. Frontload module 106 may then iteratively calculate the foregoing function for a set of possible test frontload inventory quantities and select a final frontload inventory quantity as the test frontload inventory quantity that yields the lowest value of the foregoing function.

Various products may be described herein as “weather-dependent.” In other words, sales of these products may vary based on various weather conditions (due to purchasers' needs for these products under specific weather conditions, etc.) As one illustrative example, region 120 may be prone to snowfall during a nine-week span that includes portions of the months of October, November, and December. Consequently, frontload module 106 may assign to the second week of December (in a selected future time frame) frame a high-precipitation category, based on past weather data 126 and probability calculations extrapolated therefrom. For instance, frontload module 106 may consider past occurrences of each precipitation category for each week in past years, and derive probabilities of each precipitation category based on past occurrences. For each week, the probability of each precipitation category may be employed by frontload module 106 to assign a category to the week.

In one example, frontload module 106 assigns the high-precipitation category to the second week of December if module 106 determines that that the high-precipitation category has a higher probability of occurrence in the second week of December than the no and low-precipitation categories. More specifically, in this particular example, frontload module 106 may assign a high-snowfall segment (e.g., 3 inches of snow and greater) to the second week of December. In this example, frontload module 106 may process past sales data 128 pertaining to a weather-dependent good (e.g., snow shovels) during the second week of December of a prior year that had snowfall of 3 inches or greater. Based on the processed portions of past sales data 128, frontload module 106 may determine a quantity of snow shovels that are predicted to be sold during the second week of December. Similarly, frontload module 106 may assign various weather classifications to each segment of the time frame, based on probability information extrapolated from data 132. By aggregating the assigned weather classifications across a time frame, frontload module 106 may generate one or more weather scenarios associated with the time frame. Additionally, by applying past sales data 128 of a product as it relates to a generated weather scenario, frontload module 106 may implement techniques of this disclosure to determine a quantity of a product that is expected to be sold at region 120 over a selected time frame.

As discussed, the retail chain may dispatch various weather-dependent goods, such as snow shovels, automobile windshield scrapers, mosquito repellant, camping equipment, and numerous others. Additionally, a selected time frame may, in some instances, coincide with a transition in weather patterns. As a result, overstocking a product may result in excess inventory that store locations 122 may not be able to sell after expiration of the selected time frame. In turn, the excess inventory may cause monetary losses in the form of lost floor space that may be used for more in-demand products, decisions to sell the surplus at a marked down price (i.e., “markdown losses” associated with selling the excess inventory at a below-cost price), and others. Similarly, a shortage may create an inability on the part of the retail chain to meet consumer demand, thus causing monetary losses in the form of lost sales (and lost profits stemming from the lost sales), loss of customer goodwill for future purchases of any product, etc.

As noted above, frontload module 106 may generate one or more of the weather classifications by segmenting past weather data 130 into multiple levels of the characteristic of the weather at the location. In the example where the characteristic corresponds to snowfall, frontload module 106 may segment past weather data 130 into multiple levels of snowfall, e.g. multiple levels of inches of snowfall. For example, frontload module 106 may segment past weather data 130 into levels corresponding to one inch of snowfall, two inches of snowfall, and so on. Additionally, frontload module 106 may analyze past sales data 130 associated with a product (e.g., snow shovels) and the segmented levels of snowfall to determine unit sales of the product at each segmented level of snowfall. In the example described above, frontload module 106 may analyze past sales data 130 as it relates to snow shovels at each segmented level of snowfall (measured in inches of snowfall at region 120).

In these and other implementations, frontload module 106 may cluster one or more of the segmented levels of the characteristic of the weather (e.g., snowfall levels in inches) together as a function of the determined unit sales of the product (e.g., snow shovels) at each segmented snowfall level included in the cluster. For example, frontload module 106 may cluster together segmented snowfall levels that correspond to snowfall ranging from one inch to three inches. In this example, frontload module 106 may cluster together segmented snowfall levels that correspond to snowfall ranging from four inches to a highest recorded level of snowfall provided in past weather data 130. In turn, frontload module 106 may define the weather classifications as comprising all levels of snowfall included in the segmented snowfall levels included in each cluster. For example, the clusters described above may correspond to low-snowfall and high-snowfall weather classifications, respectively. Additionally, a segmented level corresponding to zero inches of snowfall may form a separate cluster corresponding to a no-snowfall weather classification.

Frontload module 106 may cluster the segmented level(s) of snowfall in a variety of ways. In one example, frontload module 106 may determine, for each segmented snowfall level at region 120 and in comparison to a respective previous segmented snowfall level, a change in sales of the product. More specifically, frontload module 106 may determine a change in unit sales of snow shovels corresponding to a shift from zero to one-inch of snowfall, from one-inch to two-inches, from three-inches to four-inches, and so on. In this manner, frontload module 106 may determine, based on all changes in unit sales across segmented levels of snowfall, a set (or plurality) of sales transitions. In turn, each sales transition may indicate a difference between past sales data 130 of the product associated with consecutive segmented levels of snowfall. For example, a sales transition associated with a one-inch snowfall level may indicate a difference in sales of snow shovels between times corresponding to one inch of snowfall and zero inches of snowfall.

In some such examples, frontload module 106 may select a greatest sales transition from the set of sales transitions, and demarcate segmented levels based on the selected greatest sales transition. In one example, frontload module 106 may determine that the greatest sales transition of snow shovels occurs in a shift from a three-inch snowfall segment to a four-inch snowfall segment. In this example, frontload module 106 may demarcate the low-snowfall and high-snowfall weather classifications based on a shift from the three-inch snowfall segment to the four-inch snowfall segment. More specifically, frontload module 106 may designate snowfall levels of three inches and below as a low-snowfall classification, and designate snowfall levels of four inches and above as a high-snowfall classification.

As described above with respect to clustering, frontload module 106 may define weather classifications in terms of various aggregated precipitation levels. In the example described above, frontload module 106 may define the weather classifications as a zero-snowfall category, a low-snowfall category, and a high-snowfall category. In other examples, frontload module 106 may define a different set of weather classifications, and different sets of weather classifications may include varying numbers of weather classifications.

In various scenarios, regions may include different numbers of store locations. In an example where a region includes a single store location, frontload module 106 may allot the entire frontload inventory quantity to the single store location of the region. In other scenarios, such as the specific example of FIG. 1, a region may include multiple store locations. In such scenarios, frontload module 106 may allocate the frontload inventory quantity among the store locations at the particular region.

For example, in addition to determining a final frontload inventory quantity of snow shovels to dispatch to region 120, frontload module 106 may allocate the final frontload quantity of snow shovels among store locations 122. Frontload module 106 may allocate the final frontload inventory quantity among store locations 122 using a variety of methodologies. In one example, frontload module 106 may allocate the final frontload inventory quantity by dividing it equally among store locations 122. In other examples, frontload module 106 may divide the final frontload inventory quantity into sub-quantities (namely, store frontload inventory quantities 134, alternatively referred to herein as “store allocations”) such that the store frontload inventory quantities allocated across store locations 122 are different from one another.

In examples where frontload module 106 allocates varying store frontload inventory quantities across store locations 122, frontload module 106 may base the allocation on characteristics of each of store locations 122. Examples of such characteristics include store-specific information, such as store-specific past sales data associated with the product and time frame, available floor space associated with the product at a particular store location, etc. For example, past sales data 128 may include data pertaining to sales of snow shovels at store locations 122 during the winter time frame of one or more past years. If store location 122A shows consistently stronger sales of snow shovels during the winter time frame when compared to store location 122B, frontload module 106 may divide the frontload inventory quantity such that store frontload inventory quantity 134A is greater than store frontload inventory quantity 134B. In an example where frontload module 106 uses available floor space as a factor, store location 122B may include greater floor space dedicated to snow shovels than does store location 122C. In this example, frontload module 106 may divide the frontload inventory quantity of snow shovels such that store frontload inventory quantity 134B is greater than store frontload inventory quantity 134C.

Other characteristics of stores 122 that frontload module 106 may use in dividing frontload inventory quantities may include ease with which excess inventory of a product may be returned or redistributed from each of store locations 122, and ease with which emergency inventory of the product may be deployed to each of store locations 122. For example, if store location 122A is more proximate to a warehouse (e.g. where the entire frontload inventory quantity for region 120 is stored) than store location 122B, frontload module 106 may determine that it would be easier for administrators of store location 122A to return excess inventory. Similarly, if store location 122A is equipped with more transportation facilities than is store location 122B, frontload module 106 may determine that administrators of store location 122A may more easily redistribute excess inventory among store locations 122B & 122C. In such scenarios, frontload module 106 may divide the frontload inventory quantity such that store frontload inventory quantity 134A is greater than each of store frontload quantities 134B & 134C.

Conversely, if frontload module 106 determines that it would be easiest for the retail chain to deploy emergency inventory to store location 122A (e.g., through proximity to the warehouse), frontload module 106 may divide the frontload inventory quantity such that store frontload inventory quantity 134A is less than each of store frontload inventory quantities 134B & 134C. More specifically, frontload module 106 may determine that, due to the increased ease with which emergency inventory may be deployed to store location 122A, administrators of store location 122A may more quickly and easily procure additional items of a product if store location 122A runs low on the product or the store inventory is exhausted due to high consumer demand. In this manner, techniques of this disclosure may enable a retail chain to divide a frontload inventory quantity among multiple stores of a region based on various store-specific characteristics and criteria.

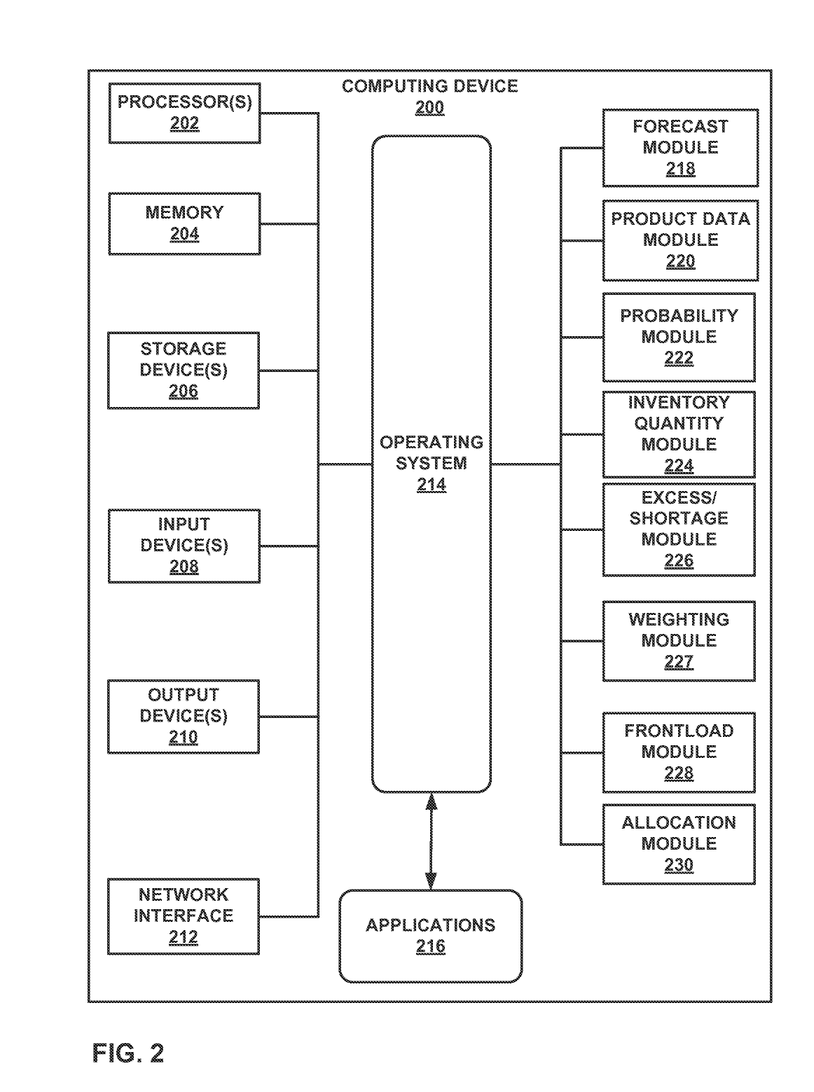

FIG. 2 is a block diagram illustrating details of an example computing device 200 that may perform one or more inventory frontloading and allocation techniques of this disclosure. Computing device 200 may be one non-limiting example implementation of computing device 102 illustrated in FIG. 1. Computing device 200 may, in various implementations, include, be, or be part of several types of devices, such as one or more of servers, client devices, desktop computers, laptop computers, netbooks, ultrabooks, tablet computers, personal digital assistants (PDAs), mobile phones (including so-called “smartphones”), etc. In various alternative implementations, one or more functionalities described herein with respect to computing device 200 may be implemented externally to computing device 200. In these alternative implementations, computing device 200 may access or otherwise avail of such functionalities using various types of communicative connections, through methods commonly known as “cloud computing.”

As shown in the example of FIG. 2, computing device 200 includes one or more processors 202, memory 204, one or more storage devices 206, one or more input devices 208, one or more output devices 210, and network interface 212. One or more processors 202 are, in some examples, configured to implement functionality and/or process instructions for execution within computing device 200. For example, processors 202 may process instructions stored in memory 204 and/or instructions stored on storage devices 206. Such instructions may include components of operating system 214, one or more applications 216, forecast module 218, product data module 220, probability module 222, inventory quantity module 224, excess/shortage module 226, frontload module 228, allocation module 230, and weighting module 227. Such instructions may include components of operating system 214, one or more applications 216, forecast module 218, product data module 220, probability module 222, inventory quantity module 224, excess/shortage module 226, frontload module 228, allocation module 230, and weighting module 227. Computing device 200 may also include one or more additional components not shown in FIG. 2, such as a power supply (e.g., a battery), and others.

In some examples, computing device 200 may include a control unit (not shown for ease of illustration purposes only), such as control unit 104 illustrated in FIG. 1. The control unit may further include or otherwise implement one or more of application(s) 216, forecast module 218, product data module 220, probability module 222, inventory quantity module 224, excess/shortage module 226, frontload module 228, allocation module 230, and weighting module 227. The control unit may, in various implementations, include any combination of one or more processors, one or more field programmable gate arrays (FPGAs), one or more application specific integrated circuits (ASICs), and one or more application specific standard products (ASSPs). The control unit may also comprise memory, both static (e.g., hard drives or magnetic drives, optical drives, FLASH memory, EPROM, EEPROM, etc.) and dynamic (e.g., RAM, DRAM, SRAM, etc.), or any other non-transitory computer readable storage medium capable of storing instructions that cause the one or more processors to perform the efficient network management techniques described in this disclosure. Thus, the control unit may represent hardware or a combination of hardware and software to support the below described components, modules or elements, and the techniques should not be strictly limited to any particular example configurations described below.

Memory 204, in one example, is configured to store information within computing device 200 during operation. Memory 204, in various examples, is described as a computer-readable storage medium and/or a computer-readable storage device. In some examples, memory 204 is a temporary memory, meaning that a primary purpose of memory 204 may not be long-term storage. Memory 204, in some examples, is described as a volatile memory, meaning that memory 204 does not maintain stored contents when memory 204 is not receiving power. Examples of volatile memories include random access memories (RAM), dynamic random access memories (DRAM), static random access memories (SRAM), and other forms of volatile memories. In some examples, memory 204 is used to store program instructions for execution by processors 202. Memory 204, in one example, is used by software (e.g., operating system 228) or applications (e.g., one or more applications 230) executing on computing device 200 to temporarily store information during program execution.

One or more storage devices 206, in some examples, also include one or more computer-readable storage media, such as a computer-readable storage device. In some examples, storage devices 206 may be configured to store greater amounts of information than memory 204. Storage devices 206 may further be configured for long-term storage of information. In some examples, storage devices 206 include non-volatile storage elements. Examples of such non-volatile storage elements include magnetic hard discs, optical discs, solid state discs, floppy discs, flash memories, forms of electrically programmable memories (EPROM) or electrically erasable and programmable memories, and other forms of non-volatile memories.

As shown in FIG. 2, computing device 200 may also include one or more input devices 208 and one or more output devices 210. Input devices 208 may include one or more of a keyboard, mouse, stylus, still camera, video camera, microphone, and other devices that are capable of receiving user input. Output devices 210 may include one or more of a monitor, speaker, video graphics adapter card, sound card, and any other device capable of generating output that may be intelligible to a user. Input devices 208 and/or output devices 210 may also include a touchscreen, presence-sensitive display, or any other input/output capable displays known in the art.

Computing device 200, in some examples, also includes network interface 212. Computing device 200, in one example, utilizes network interface 212 to communicate with external devices via one or more networks, such as one or more wireless networks. Network interface 212 may be a network interface card, such as an Ethernet card, an optical transceiver, a radio frequency transceiver, or any other type of device that can send and receive information. Other examples of such network interfaces may include Bluetooth, 3G, 4G and WiFi® radios in mobile computing devices as well as USB. In some examples, computing device 200 utilizes network interface 312 to wirelessly communicate with external devices over a network, such as database 124 and/or various computing devices located at one or more of store locations 122 of FIG. 1.

Operating system 214 may control one or more functions of computing device 200 and/or components thereof. For example, operating system 214 may interact with one or more of application(s) 216, forecast module 218, product data module 220, probability module 222, inventory quantity module 224, excess/shortage module 226, frontload module 228, allocation module 230, and weighting module 227. Additionally, operating system 214 may facilitate one or more interactions between application(s) 216, forecast module 218, product data module 220, probability module 222, inventory quantity module 224, excess/shortage module 226, frontload module 228, allocation module 230, and weighting module 227 and one or more of processors 202, memory 204, storage devices 206, input devices 208, and output devices 210. As shown in FIG. 2, operating system 214 may interact with or be otherwise coupled to application(s) 216, forecast module 218, product data module 220, probability module 222, inventory quantity module 224, excess/shortage module 226, frontload module 228, allocation module 230, weighting module 227, and various components thereof.

In some examples, operating system 214 may include or otherwise provide functionalities described with respect to one or more of application(s) 216, forecast module 218, product data module 220, probability module 222, inventory quantity module 224, excess/shortage module 226, frontload module 228, allocation module 230, and weighting module 227. In these and other examples, application(s) 216 may include one or more of forecast module 218, product data module 220, probability module 222, inventory quantity module 224, excess/shortage module 226, frontload module 228, allocation module 230, and weighting module 227. In other examples, one or more of forecast module 218, product data module 220, probability module 222, inventory quantity module 224, excess/shortage module 226, frontload module 228, allocation module 230, and weighting module 227 may be implemented externally to computing device 200, such as at a network location. In some such instances, computing device 200 may use network interface 212 to access and implement functions provided by one or more of application(s) 216, forecast module 218, product data module 220, probability module 222, inventory quantity module 224, excess/shortage module 226, frontload module 228, allocation module 230, and weighting module 227, through cloud computing and/or methods sometimes referred to as server side processing.

Forecast module 218 may be configured or otherwise operable to implement one or more weather-related functions described herein. In various examples, forecast module 218 may access past weather data (e.g., from storage devices 206 and/or an external database) pertaining to a region, and apply the past weather data to a future time frame. By applying past weather data to a future time frame (and/or time segments thereof), forecast module 218 may generate data that enables other components of computing device 200 to more efficiently and accurately implement one or more inventory frontloading techniques described herein.

For example, forecast module 218 may access past weather data for a location corresponding to the winter time frame of one or more prior years. In one example implementation, forecast module 218 may access past weather data for the location during the winter time frame of year of the past twenty years. By accessing weather data for a larger number of years, forecast module 218 may be able to normalize weather patterns (e.g., account for weather eccentricities of an abnormal year, etc.), thereby generating more robust and reliable data upon which to base a weather forecast. Additionally, by accessing weather data for a recent span of years (e.g., the twenty most recent years), forecast module 218 may base a weather forecast on more relevant weather trends, thereby accounting for changing weather trends over longer periods of time. In this manner, forecast module 218 may select and access past weather data that is pertinent to a particular region for a future time frame.

Additionally, forecast module 218 may apply the selected past weather data in order to generate weather classifications for the location during each segment of the future time frame. In the example of the nine-week winter time frame described above, forecast module 218 may apply the past weather data to generate statistics associated with each week as it relates to each of the three snowfall categories listed above (namely, the zero-snowfall, low-snowfall, and high-snowfall categories). For example, forecast module 218 may associate corresponding weeks of past years with the weather classifications experienced during those weeks. In this example, forecast module 218 may provide the mapped past weather data to other components of computing device 200, such as to probability module 222.

Using various available combinations of weather classifications over a time frame, probability module 222 may calculate or estimate the probability of each combination occurring over the time frame. As discussed, in the example of a nine-week winter time frame with three available snow segments, the number of possible combinations may be calculated as follows: 3⁹=19,683 possible combinations. In such a scenario, probability module 222 may calculate probabilities associated with each combination (referred to above as weather scenarios), using various techniques known in the art. In some examples, probability module 222 may calculate the probabilities based on the occurrences of each weather classification (in each corresponding week) over winter time frames of selected past years (e.g., as part of data received from forecast module 218). In one example, probability module 222 may calculate the probability for each weather classification occurring in each week by calculating the sum of the occurrences of the level(s) of the weather characteristic associated with the weather classification occurring in the week over the past period of time, e.g., over the past 20 years, divided by the past period of time. For example, probability module 222 may determine based on past weather data over the past 20 years that “low” snow levels have occurred 17 times in a given week of the year. In this example, the probability for that week and for that weather classification would be equal to 17/20, which is equal to 0.85. In order to determine the probability for a weather scenario, which includes weather classifications assigned to each time segment, e.g., each week in the time frame, probability module 222 may multiply the individual probabilities of each week and weather classification for the weather scenario over the time frame.

By calculating probabilities associated with each possible combination of weather classifications over the time frame (weather scenario), probability module 222 may enable other components of computing device 200 to select those combinations that have a greater probability of occurring, and assign lesser weights to those combinations that have a lower probability of occurring. In this manner, probability module 222 may emphasize more likely scenarios, while deemphasizing less likely scenarios, thereby conserving processing time and resource consumption for the more likely scenarios.

Product data module 220 may be configured or otherwise operable to access and/or process data pertaining to various products for which computing device 200 may determine frontload inventory quantities. For example, product data module 220 may access data pertaining to past sales of various products (e.g., snow shovels, ice scrapers, etc.) during particular weeks of the year and particular levels of snowfall. In addition, product data module 220 may correlate product-related data to various weather-related data generated by forecast module 218 and/or other components of computing device 200. In some examples, product data module 220 may associate various products with various time frames. In such examples, product data module 220 may thus designate various products as weather-dependent goods.

For instance, during the winter time frame described above, certain regions may be prone to snowfall. In this instance, product data module 220 may associate various products, such as snow shovels, ice scrapers, etc. with the winter time frame in a snow-prone region. Conversely, product data module 220 may dissociate such products from a summer time frame (and, for example, associate products related to warmer weather, such as insect repellant, sunblock, patio furniture, etc.). In addition, product data module 220 may access, analyze, and/or process past sales data associated with such products during past time segments associated with currently available weather classifications.

For example, in anticipation of an upcoming winter time frame, product data module 220 may process past sales data for snow shovels during weeks having each of high, low, and zero snow segments during one or more past winter time frames. By processing the past sales data for snow shovels during past winters, for multiple snowfall segments, product data module 220 may generate data that predicts snow shovel sales in the region for the upcoming winter time frame. In this manner, product data module 220 may process data which, in conjunction with data generated by forecast module 218 and/or probability module 222, may enable computing device 200 to predict quantities of weather-dependent goods that may be sold in a particular region during an upcoming season/time frame.

In one example, product data module 220 may calculate a forecast of unit sales of a product over the time frame for each weather scenario generated by forecast module 218. In various examples, product data module 220 may calculate the forecast of unit sales of the product based on criteria including past weather data for the location, past sales data for the product with respect to both of the product and the weather classifications, etc. In one example, product data module 220 may calculate the forecast of unit sales of a product over the time frame for each weather scenario generated by forecast module 218 in a manner similar to that described above with reference to frontload module 106 of FIG. 1.

In the implementation illustrated in FIG. 2, computing device 200 includes inventory quantity module 224. Inventory quantity module 224 may be configured or otherwise operable to implement one or more techniques of this disclosure, including iterative selection of a set of test frontload inventory quantities for the product. Additionally, inventory quantity module 224 may be configured to calculate a function including the sum of the products of the probability that each weather scenario will occur and the difference between each test frontload inventory quantity and the forecasted unit sales of the product for each scenario. In some example, inventory quantity module 224 may apply the formula described above with respect to frontload module 106 of FIG. 1. In applying the formula, inventory quantity module 224 may apply data received from probability module 222, excess/shortage module 226, and weighting module 227.

As shown in FIG. 2, computing device 200 may also include excess/shortage module 226. Excess/shortage module 226 may, in various implementations, determine values associated with the various values of the test inventory quantity generated by inventory quantity module 224. Examples of such values include an overstock amount (or “surplus”) and a shortage amount. As described, a surplus of the product (e.g., snow shovels) may be a number by which an inventory quantity exceeds a demand value, and conversely, the shortage amount may be a number by which a demand value exceeds an inventory quantity. As described, excess/shortage module 226 may supply the determined overstock and shortage amounts to inventory quantity module 224 for use in calculation of the test frontload inventory quantity function.

In some implementations, computing device 200 may include weighting module 227. 227227 When implemented in computing device 200, weighting module 227 may be configured or otherwise operable to assign a weight to each of the excess inventory amount and the shortage amount determined by excess/shortage module 226. Weighting the excess inventory amount and the shortage amount may be employed to bias frontload inventory determinations toward surplus of a product over the time frame or toward running out of stock of the product toward the end of the time frame. The weighting toward surplus or shortage may be based on or indicative of the relative risks of each alternative. An example of a risk associated with overstocking a product is monetary loss caused by selling excess inventory of snow shovels at markdown prices after the end of a winter time frame. Other risk factors associated with overstocking of products may include lost floor space (i.e., store or warehouse floor space occupied by the excess snow shovels) that may be used for other products in time frames following winter, transport costs associated with removal of excess inventory from a store or region, etc. Similarly, stocking a shortage of a product may be associated with risks such as potential lost profits associated with an inability to meet consumer demand for snow shovels during the winter frame, lost profits resulting from a loss of customer goodwill, loss of repeat customers who may later patronize another retail chain for shopping needs other than for snow shovels, etc.

In one example, weighting module 227 may communicate the determined weights to inventory quantity module 224 for use in iteratively calculating the function with respect to various test frontload inventory quantities. Weighting module 227 may determine the weights for the overstock and shortage amounts based on various criteria. For example, weighting module 227 may determine the weights based on a frequency with which a retailer using computing device 200 prefers to maintain inventory of a product at a location over a time frame. As described above, in an example where the retailer prefers to maintain inventory 95% of the time, weighting module 227 may attach a weight of nineteen to the overstock amount as compared to a weight of one to the shortage amount. In this manner, weighting module 227 may enable inventory quantity module 224 to skew calculation of the function in favor of either surplus or shortage of a particular product at the location over the time frame.

Computing device 200 may further include frontload module 228. In various implementations, frontload module 228 may be configured to select one of the test frontload inventory quantities used by inventory quantity module 224 as a final frontload inventory quantity for a product based on the function calculated by inventory quantity module 224. More specifically, frontload module 228 may select the final frontload inventory quantity based on the results of the function calculated by inventory quantity module 224 with respect to each test frontload inventory quantity. For example, frontload module 228 may select the final frontload inventory quantity by iteratively calculating the function described above with reference to FIG. 1 for a set of possible test frontload inventory quantities and select a final frontload inventory quantity as the test frontload inventory quantity that yields the lowest value of the function.

As shown in FIG. 2, computing device 200 may also include allocation module 230. As described, a region (e.g., for which frontload module 228 determines a frontload inventory quantity of a product may) include one or more store locations. In regions which include only a single store location, the retail chain using computing device 200 may deploy the entire frontload inventory quantity to the single store location. However, if a region includes more than one store location, allocation module 230 may divide the frontload inventory quantity to form several store frontload inventory quantities, each being associated with a single store location in the region.

As described with respect to FIG. 1, allocation module 230 may divide the frontload inventory quantity based on a characteristic of each store location in the region. Examples of store characteristics may include store-specific past sales data for the product in a corresponding time frame of a prior year, available floor space dedicated to the product at each store location, and others. Additionally, in various scenarios, allocation module 230 may divide the frontload inventory quantity such that 2 or more of the store frontload inventory quantities are different from one another, or divide the frontload inventory quantity equally among the store locations of the region. In this manner, allocation module 230 may implement the techniques of this disclosure to divide the frontload inventory quantity of a product in a variety of ways, and allocate the resulting store frontload inventory quantities among store locations of a region.

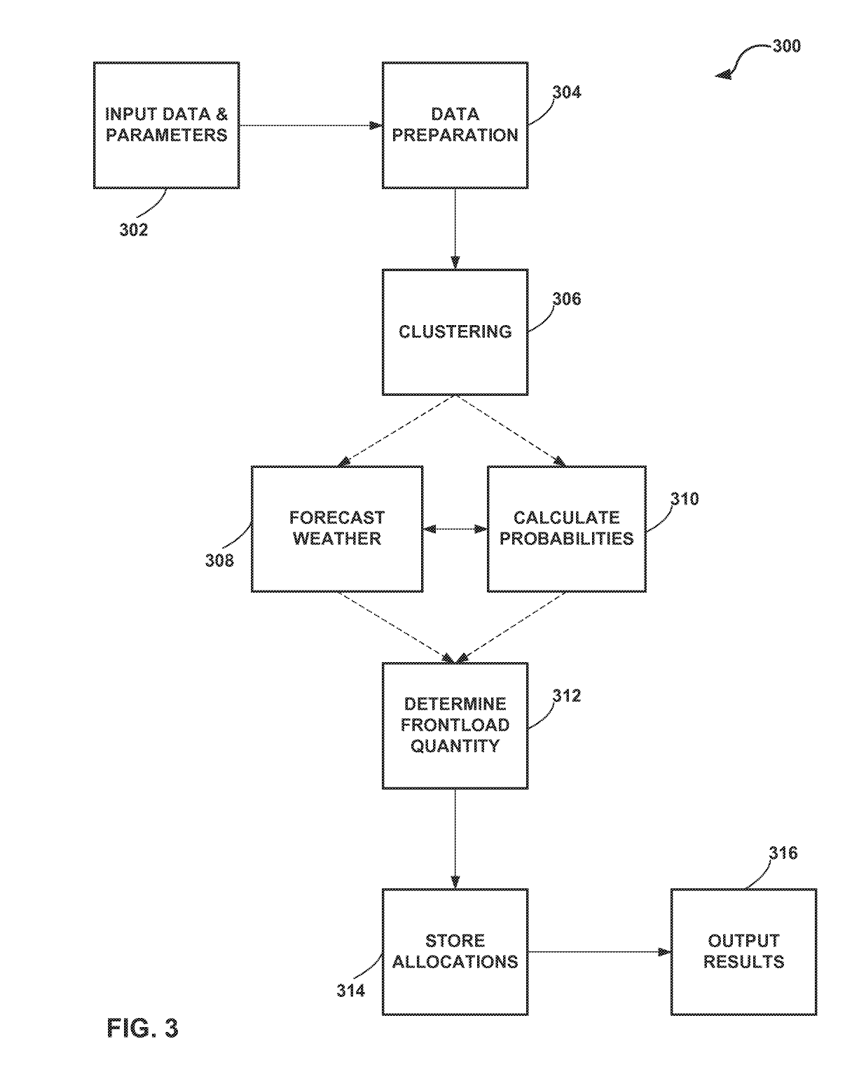

FIG. 3 is a flowchart illustrating an example process 300 that a computing device may perform to implement one or more product inventory frontloading and allocation techniques of this disclosure. Although process 300 may be performed by any computing device described herein (and/or any combination thereof), for purposes of illustration, process 300 is described herein with respect to computing device 200 of FIG. 2.

Process 300 may begin when computing device 200 receives data and/or parameters that are input from one or more sources (step 302). For example, the data may include past sales data associated with various products, historical weather data associated with various regions, mapping of each store location to a nearest warehouse, and others. Similarly, the parameters may include information associated with the time frame (e.g., start and end dates), region locations, etc. Computing device 200 may receive the data and parameters using network interface 212, input devices 208, etc. In some examples, computing device 200 may store the data and parameters to storage devices 206 and/or to other storage locations accessible via network interface 212.

Computing device 200 (and/or components thereof) may then prepare the input data (step 304). In various examples, data preparation may include removing outlier information, such as data points that are outside certain predetermined bounds, etc. For example, computing device 200 may prepare the input data by removing past sales data that exceeds or falls short of expected bounds by certain predetermined margins. Additionally, computing device 200 may cluster the prepared data (step 306). More specifically, computing device 200 may use one or more of the received parameters including data related to past weather conditions for the region and/or various clustering heuristics, such as the clustering techniques described above. Clustering weather data may be employed to generate a number of weather classifications, e.g. levels of snowfall like zero, low, and high snowfall for a region during a particular time frame.

In the example of the winter time frame in a snow-prone region described above, computing device 200 may cluster past sales data of a product (e.g., snow shovels) as the past sales relate to ranges of snowfall. For example, computing device 200 may discretize the past sales of snow shovels based on zero, low, and high snowfall categories, which may include multiple levels or segments of snowfall precipitation. Additionally, computing device 200 may use a clustering heuristic (e.g., sales transitions between different snowfall levels determined from past sales of snow shovels) to determine a demarcation between the low and high snow categories. For example, computing device 200 may demarcate the low and high snow categories based on a point at which snow shovel sales increase by a threshold amount (e.g., as may be shown by the gradient of a slope, or by the highest discerned sales transition within the available past sales data).

Additionally, computing device 200 may forecast unit sales of a product in a particular region during the selected future time frame (step 308). More specifically, forecast module 218 may use historical weather data in conjunction with past sales data to forecast sales for the upcoming winter time frame. The unit sales may be forecast for each of a number of different possible weather scenarios for the winter time frame, e.g., in a manner similar to that described above. In conjunction with (and/or concurrently with) forecasting unit sales of the product over the time frame, computing device 200 may calculate probabilities of possible combinations of weather classifications over the time frame (step 310). More specifically, probability module 222 may draw on historical weather data to calculate probabilities associated with each possible combination of weather classifications (e.g., the 3⁹ combinations described above) to determine which combinations are most likely to occur in the upcoming winter time frame.

Computing device 200 may determine the frontload inventory quantity for snow shovels for a given region over the winter time frame (step 312). More specifically, inventory quantity module 224 may iteratively select test frontload inventory quantities of the product and calculate the function described above for each test frontload inventory quantity. In addition, excess/shortage module 226 may determine either an overstock amount or a shortage amount with respect to snow shovels for the region for the winter time frame, and weighting module 227 may determine and attach weights to the overstock amount or the shortage amount, as the case may be. Using the results of the calculated function with respect to the various test frontload quantities along with the weighted overstock amount or the weighted shortage amount, frontload module 228 may select a final frontload inventory quantity for the product at the region over the time frame.

After determining the frontload inventory quantity for a region, computing device 200 may allocate the frontload inventory quantity across various store locations in the region (step 314). As described, allocation module 230 may use various criteria, such as one or more characteristics compared across the store locations, in allocating the store frontload inventory quantities. Additionally, computing device 200 may output the results, such as the frontload inventory quantity and/or the store frontload inventory quantities (step 316). In various instances, computing device 200 may output the results using network interface 212, output device(s) 210, and others. In some examples, computing device 200 may output the results in the form of an instruction to place the frontload inventory quantity of the product in inventory for the region prior to or at the beginning of the particular time frame. In some such examples, the instruction may include store frontload inventory quantities resulting from the allocation across the store locations of the region.

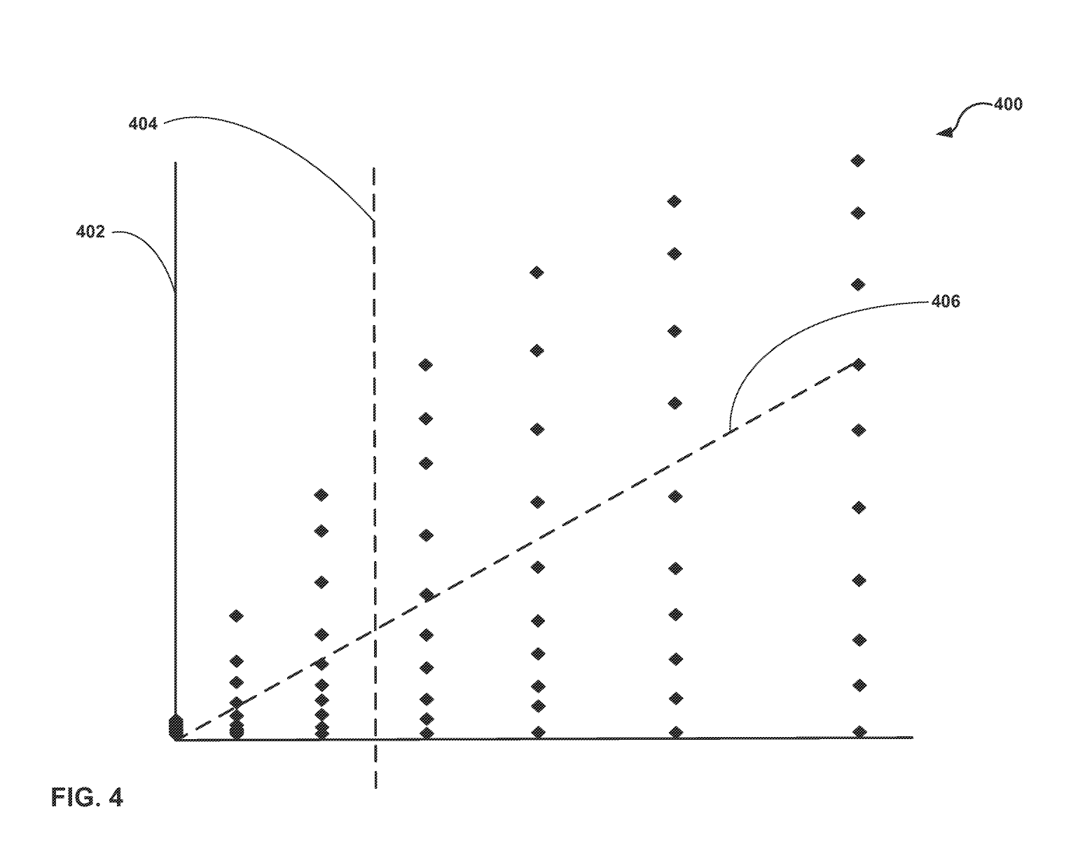

FIG. 4 is a graph 400 illustrating sales clustering of a precipitation-specific product in a particular region, across varying levels of precipitation. The horizontal (x−) axis of graph 400 represents snowfall (in inches), while the vertical (y−) axis represents sales of snow shovels. For ease of discussion purposes only, graph 400 is described herein with respect to snow shovels as the product and snowfall segments as the weather classifications. Graph 400 includes three distinct clusters of sales data, demarcated by y-axis 402, and snowfall threshold 404. For example, y-axis 402 represents a zero-snowfall segment, and shows a clustering often stores that have sold zero or near zero shovels during zero-snowfall weeks during the winter time frame(s) of one or more past years. Snowfall threshold 404 is described in more detail below

Additionally, FIG. 4 illustrates regression line 406. A computing device implementing the techniques of this disclosure may use methods such as linear regression to construct regression line 406. In various examples, regression line 406 (though not drawn to scale for ease of illustration purposes) may connect average points across the various sales clusters illustrated in FIG. 4. Examples of averages include values such as the mean, median, and mode of snow shovel sales at each level of snowfall.

A computing device implementing the techniques of this disclosure may extrapolate or otherwise forecast snow shovel sales for various levels of snowfall using regression line 406. For example, for a snowfall level for which past sales data are not available, the computing device may plot an intersection of regression line 406 with a vertical line drawn from the particular snowfall level shown on the x-axis of graph 400. In this manner, a computing device may implement the techniques of this disclosure to predict snow shovel sales at a particular snowfall level. Additionally, in the event a weather classification includes multiple snow fall levels, e.g. between zero and three inches of snow, the computing device may calculate forecasted snow shovel sales for such a weather classification as the average of regression line 406 from zero to three inches.

Additionally, the computing device may (e.g., by linear regression), determine sales transitions between consecutive snowfall levels. For example, the computing device may determine an increase shift in snow shovel sales from a snowfall level one inch to two inches, two inches to three inches, and so on. Based on the determined sales transitions, the computing device may determine a greatest sales transition, e.g., a snowfall level that shows the greatest increase in snow shovel sales over its immediately preceding snowfall level. The computing device may discern the greatest sales transition based on various factors, such as a linear increase in sales units, a percentage increase, and others. Based on the greatest sales transition, the computing device may designate a demarcation at snowfall threshold 404. In examples, snowfall threshold 404 may represent a demarcation between a low-snowfall category and a high-snowfall category. In this manner, the computing device may use methods such as linear regression to determine and demarcate various weather classifications for product inventory frontloading

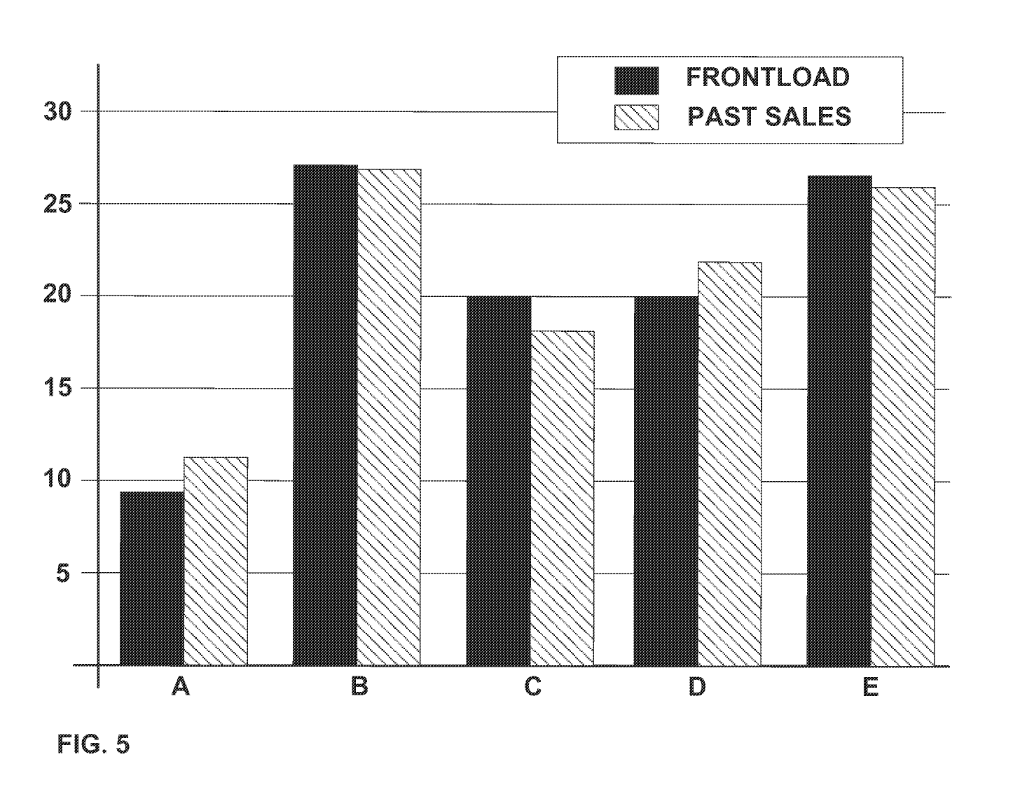

FIG. 5 is a graph 500 illustrating allocation of frontload inventory across various store locations of a particular region. It will be appreciated that the store allocation of frontload inventory illustrated in graph 500 may be determined using various devices (and components thereof) in accordance with one or more aspects of this disclosure. However, for purposes of illustration, graph 500 is described herein with respect to allocation module 230 of computing device 200 illustrated in FIG. 2.

As shown in FIG. 5, graph 500 includes past sales data, as well store frontload inventory data pertaining to five stores (store locations A-E, plotted on the horizontal axis, or x-axis of graph 500). Quantity data (represented in units, cases, dozens of units, or any other quantitative calibration) is plotted on the vertical axis, or y-axis, of graph 500. More specifically, distribution over the y-axis may represent the percentage of a total quantity pertaining to each store. For instance, the past sales data represents the percentage of past sales attributed to each store, and the frontload data represents the percentage of the available frontload amount assigned to each store.

As discussed, allocation module 230 may divide the frontload inventory quantity for a region including store locations A-E in a variety of ways. In the example illustrated in graph 500, allocation module 230 may divide the frontload inventory quantity unequally among store locations A-E. As discussed, allocation module 230 may divide the frontload inventory quantity unequally based on various criteria, such as past sales data and others.

In the example of store locations A-E, past sales data varies among stores, as shown by the striped bars for each respective store. For example, the past sales of a product (e.g., mean sales of snow shovels during winter time frames of the last five years) at store location A may be half or less of the corresponding past sales at store location B. More specifically, store location B may account for over 25% of past sales of a product, while store location A may account for just over 10% of past sales of the product. Additionally, as shown in FIG. 5, allocation module 230 may or may not generate a particular store frontload inventory quantity in equal proportion to the corresponding past sales data for a store location. For example, the frontload allocation for store location A is less than the past sales percentage for store location A. In contrast, the frontload allocation for store location B is substantially equal to the past sales percentage for store location B. In further contrast, the frontload allocation for store location C is greater than the past sales percentage for store location C. In an example where store locations A-E represent all of the store locations in a particular region, the aggregate of the frontload allocations for store locations A-E may represent the frontload inventory quantity for the region (i.e., totaling 100% of the frontload inventory quantity for the region.

As discussed, allocation module 230 may vary the frontload allocations for store locations A-E based on a variety of criteria. As one example, allocation module 230 may determine that floor space dedicated to the product at store location A has diminished since one or more times when the past sales amount was determined. As another example, allocation module 230 may determine that the past sales amount (if it represents an average amount for a number of past years) for store location C has shown an upward trend, thus warranting a higher frontload allocation for store location C. In this manner, allocation module 230 may implement the techniques of this disclosure to divide a region's frontload inventory quantity among store locations in a variety of ways, and based on various criteria (or sets of criteria).

Techniques described herein may be implemented, at least in part, in hardware, software, firmware, or any combination thereof. For example, various aspects of the described embodiments may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units are realized by separate hardware, firmware, or software components. Rather, functionality associated with one or more modules or units may be performed by separate hardware, firmware, or software components, or integrated within common or separate hardware, firmware, or software components.

Techniques described herein may also be embodied or encoded in an article of manufacture including a computer-readable storage medium encoded with instructions. Instructions embedded or encoded in an article of manufacture including an encoded computer-readable storage medium, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. Additional examples of computer readable medium include computer-readable storage devices, computer-readable memory, and tangible computer-readable medium. In some examples, an article of manufacture may comprise one or more computer-readable storage media.

In some examples, computer-readable storage media may comprise non-transitory media. The term “non-transitory” may indicate that the storage medium is tangible and is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
generating, by a computing device, a plurality of weather classifications for a location based on past weather data for the location, wherein each weather classification represents a level of a characteristic of the weather at the location;
generating, by the computing device, a plurality of weather scenarios for a time frame comprising a plurality of time segments over which sales of a product will occur in the future, wherein each weather scenario comprises a different combination of weather classifications assigned to each of the time segments in the time frame;
calculating a forecast of unit sales of the product over the time frame for each weather scenario based on the past weather data for the location and past sales data associated with both the product and the weather classifications;
calculating a probability that each weather scenario will occur in the time frame;
iteratively selecting a plurality of test frontload inventory quantities for the product and calculating a function comprising the sum of the products of the probability that each weather scenario will occur and the difference between each test frontload inventory quantity and the forecasted unit sales of the product for each weather scenario, wherein a frontload inventory quantity comprises a quantity of the product to place in inventory prior to or at the beginning of the time frame configured to approximate demand for the product over the entire time frame;
selecting one of the test frontload inventory quantities as a final frontload inventory quantity for the product based on the calculated function for each of the test frontload inventory quantities; and
wherein the difference between each test frontload inventory quantity and the forecasted unit sales of the product for each weather scenario further comprises one of an estimated excess or shortage inventory quantity of the product, and further comprising assigning a first weight to the estimated excess inventory quantity and a second weight to the estimated shortage inventory quantity.

2. The method of claim 1, wherein generating one of the weather classifications for the location based on past weather data for the location comprises:
segmenting past weather data into multiple segmented levels of the characteristic of the weather at the location;
analyzing past sales data associated with both the product and the segmented levels of the characteristic of the weather at the location to determine unit sales of the product at each of the segmented levels of the characteristic of the weather at the location;
clustering one or more of the segmented levels of the characteristic of the weather at the location together as a function of the determined unit sales of the product at each of the one or more segmented levels of the characteristic of the weather included in the cluster;
defining the one of the weather classifications as comprising all levels of the characteristic of the weather at the location included in the one or more segmented levels of the characteristic of the weather included in the cluster.

3. The method of claim 2, wherein clustering the one or more segmented levels of the characteristic further comprises:
determining, for each segmented level of the characteristic of the weather at the location and in comparison to a respective previous segmented level of the characteristic of the weather at the location, a respective change in sales of the product;
determining, based on all determined changes in sales of the product for all of the segmented levels of the characteristic of the weather at the location, a plurality of sales transitions, each sales transition indicating a difference between past sales of the product associated with consecutive segmented levels of the segmented levels of the characteristic of the weather at the location.

4. The method of claim 3, further comprising:
selecting a greatest sales transition from the plurality of sales transitions; and
demarcating all segmented levels of the characteristic of the weather at the location on one side of the greatest sales transitions from all segmented levels of the characteristic of the weather at the location on the other side of the greatest sales transition.

5. The method of claim 2, wherein the segmented levels of the characteristic of the weather at the location comprise amounts of precipitation at the location and wherein segmenting, analyzing, clustering, and defining is repeated for each of the weather classifications such that each weather classification comprises all of the amounts of precipitation included in the one or more segmented amounts of the precipitation included in the cluster by which the weather classification is defined.

6. The method of claim 1, wherein generating the weather scenarios for the time frame comprising the time segments comprises generating a weather scenario for each different combination of weather classification and time segments for the time frame.

7. The method of claim 1, wherein each weather classification at the location is associated with a precipitation level at the location for each time segment of the time frame.

8. The method of claim 7, wherein the precipitation level is associated with at least one of a snowfall amount and a rainfall amount.

9. The method of claim 1, wherein the plurality of weather classifications comprises a zero-snowfall, a low-snowfall, and a high-snowfall category.

10. The method of claim 1, wherein the function for calculating the frontload inventory quantity is
ΣₓεxP(X≈x)(wₑeₓ+wₛsₓ)
where X is the set of all weather scenarios:
P(X≈x) is the probability of a weather scenario x,
eₓ and sₓ are estimated excess and shortage inventory quantities, respectively, for the weather scenario x, and,
wₑ and wₛ represent weights that the frontload module attaches to an estimated excess amount and a shortage amount of the product, respectively, in order to skew a calculation of the frontload inventory quantity.

11. The method of claim 10, wherein the first weight has a value of 19 (nineteen) and the second weight has a value of 1 (one).

12. The method of claim 1, wherein the location includes one or more store locations, the method further comprising:
dividing the final frontload inventory quantity into store allocations, wherein each store allocation is associated with a store location at the location.

13. The method of claim 12, wherein dividing the final frontload inventory quantity comprises dividing the final frontload inventory quantity such that all of the store allocations are equal.

14. The method of claim 12, wherein dividing the final frontload inventory quantity comprises dividing the final frontload inventory quantity based on store-specific information associated with each store location at the location.

15. The method of claim 1, further comprising:
stocking the final frontload inventory quantity of the product at the location.

16. The method of claim 1, wherein calculating the forecast of unit sales of the product over the time frame for each weather scenario further comprises:
generating, by the computing device, a linear regression across the past sales data corresponding to all weather classifications of the plurality of weather classifications, wherein each weather classification comprises multiple levels of the characteristic of the weather at the location; and
for each weather classification, calculating, by the computing device, an average of the linear regression across the past unit sales data for all levels of the characteristic of the weather at the location to determine a forecast of unit sales of the product for the weather classification; and
summing, by the computing device, the forecast of unit sales of the product for each weather classification assigned to each of the time segments in the time frame for the weather scenario.

17. A computing device comprising:
a computer readable storage memory; and
at least one processor configured to access information stored on the computer readable storage medium and to perform operations comprising:
generating a plurality of snowfall categories for a region based on past weather data for the region, wherein each snowfall category represents a range of a characteristic of the weather at the region;
generating a plurality of snowfall category combinations for a time frame comprising a plurality of time segments over which sales of a weather-dependent product will occur in the future, wherein each snowfall category combination comprises a different combination of snowfall categories assigned to each of the time segments in the time frame;
calculating a forecast of unit sales of the weather-dependent product over the time frame for each snowfall category combination based on the past weather data for the region and past sales data associated with both the weather-dependent product and the snowfall categories;
calculating a probability that each snowfall category combination will occur in the time frame;
iteratively selecting a plurality of preliminary frontload inventory quantities for the weather-dependent product and calculate a function comprising the sum of the weather-dependent products of the probability that each snowfall category combination will occur and the difference between each preliminary frontload inventory quantity and the forecasted unit sales of the weather-dependent product for each snowfall category combination, wherein a frontload inventory quantity comprises a quantity of the weather-dependent product to place in inventory prior to or at the beginning of the time frame configured to approximate demand for the product over the entire time frame; and
selecting one of the preliminary frontload inventory quantities as a frontload inventory quantity for the weather-dependent product based on the calculated function for each of the preliminary frontload inventory quantities;
wherein the function for calculating the frontload inventory quantities is
ΣₓεxP(X≈x)(wₑeₓ+wₛsₓ)
where X is the set of all weather scenarios:
P(X≈x) is the probability of a weather scenario x,
eₓ and sₓ are estimated excess and shortage inventory quantities, respectively, for the weather scenario x, and,
wₑ and wₛ represent weights that the frontload module attaches to an estimated excess amount and a shortage amount of the product, respectively, in order to skew a calculation of the frontload inventory quantities.

18. The computing device of claim 17, wherein the at least one processor is configured to generate one of the snowfall categories for the region at least in part by:
categorizing past weather data into multiple snowfall levels at the region; analyzing past sales data associated with both the weather-dependent product and the snowfall levels at the region to determine unit sales of the weather-dependent product at each of the snowfall levels at the region;
grouping one or more of the snowfall levels at the region together as a function of the determined unit sales of the weather-dependent product at each of the one or more snowfall levels in the group; and
defining the one of the snowfall levels as comprising all snowfall levels included in the one or more categorized snowfall levels included in the group.

19. The computing device of claim 18, wherein the at least one processor is configured to categorize the past weather data into the multiple snowfall levels at the region at least in part by:
determining, for each snowfall level at the region and in comparison to a respective previous snowfall level at the region, a respective change in sales of the weather-dependent product; and
determining, based on all determined changes in sales of the weather-dependent product for all of the snowfall levels at the region, a plurality of sales increases, each sales increase indicating a difference between past sales data of the weather-dependent product associated with consecutive snowfall levels at the region.

20. A non-transitory computer-readable storage medium encoded with instructions that, when executed, cause one or more processors of a computing device to:
generate a plurality of weather classifications for a location based on past weather data for the location, wherein each weather classification represents a level of a characteristic of the weather at the location;
generate a plurality of weather scenarios for a time frame comprising a plurality of time segments over which sales of a product will occur in the future, wherein each weather scenario comprises a different combination of weather classifications assigned to each of the time segments in the time frame;
calculate a forecast of unit sales of the product over the time frame for each weather scenario based on the past weather data for the location and past sales data associated with both the product and the weather classifications;
calculate a probability that each weather scenario will occur in the time frame; determine a frontload inventory quantity for the product based on the calculated forecast of unit sales of the product over the time frame and the probabilities that each weather scenario will occur in the time frame using a function for calculating the frontload inventory quantity which includes estimated excess and shortage inventory quantities and a factor that ascribes a weight to the estimated excess and shortage amounts in order to skew the calculation of the frontload inventory calculation.
